(19) United States
(12) Patent Application Publication
(10) Pub. No.: US 2012/0330506 A1
(43) Pub. Date: Dec. 27, 2012

(54) METHOD FOR DETERMINING AND DETECTING END STOPS OF A STEERING DEVICE OF A MOTOR VEHICLE AND A MOTOR VEHICLE USING SUCH METHOD

(75) Inventors: Peter KLEINHANS, Buerstadt (DE); Matthias REBEL, Dreieich (DE)

(73) Assignee: GM GLOBAL TECHNOLOGY OPERATIONS LLC, Detroit, MI (US)

(21) Appl. No.: 13/526,835

(22) Filed: Jun. 19, 2012

(30) Foreign Application Priority Data
Jun. 21, 2011 (DE) 10 2011 105 064.0

(51) Int. Cl. G06F 17/00; B62D 5/04

(52) U.S. Cl. 701/36

(57) ABSTRACT

A method for determining and detecting end stops of a steering device of a motor vehicle, which has a servomotor, is provided. The method includes determining actual, mechanical end stops of the steering device and establishing software-controlled end stops after the actual, mechanical end stops are determined A motor vehicle comprising a steering device for the wheels of the motor vehicle is also provided. The steering device includes a servomotor and a control unit. The control unit controls the servomotor. The control unit is configured to specify software-controlled end stops for the wheels of the motor vehicle and to determine software-controlled end stops after reaching and determining actual, mechanical end stops of the wheels.

### CROSS-REFERENCE TO RELATED APPLICATION

This application claims priority to German Patent Application No. 10 2011 105 064.0, filed Jun. 21, 2011, which is incorporated herein by reference in its entirety.

### TECHNICAL FIELD

The technical field relates to a method for determining and detecting end stops of a steering device of a motor vehicle, which has a servomotor. The technical field further relates to a motor vehicle comprising a steering device for the wheels thereof, wherein the steering device has a servomotor and a control unit, wherein the control unit controls the servomotor and wherein the control unit specifies software-controlled end stops for the wheels of the motor vehicle.

### BACKGROUND

Steering devices are used for steering the wheels of a motor vehicle. Usually, such a steering device comprises a steering wheel which is connected with an input shaft. The input shaft leads to a steering gear, which converts the rotation of the steering wheel or respectively of the input shaft such that the wheels of the motor vehicle are turned.

The wheels are turned via tie rods which are connected with the steering gear. The rotation axes of the turned wheels then form an angle with the longitudinal axis of the motor vehicle. The steering movement of the vehicle driver is usually assisted by a servomotor, which generates a torque.

From DE 10 2006 003 428 A1 a steering device is known, in which it is ensured by a control unit that the servomotor does not block a desired steering movement of the vehicle driver.

The control unit is controlled by software so that the wheels, after reaching a software-controlled end stop, can still be brought further towards mechanical end stops by the vehicle driver. The effort for this depends on the overall transmission of the steering device.

In the steering device of the prior art, a software-controlled end stop, determined by the control unit, can indeed be exceeded by increased effort by the vehicle driver. However, the instance can occur that the control unit in no state detects the actual mechanical end stop.

Thus, there is a need of indicating a motor vehicle with a servomotor-assisted steering device, the turning circle of which is optimized.

### SUMMARY

In an embodiment, a method for determining and detecting end stops of a steering device of a motor vehicle, which has a servomotor, includes the steps:
determining the actual, mechanical end stops of the steering device; and
establishing the software-controlled end stops, after the actual, mechanical end stops are determined.

It has firstly been recognized that in steering devices of the prior art, within a predeterminable range of the software of the control unit, each position can be accepted as a software-controlled end stop. A software-controlled end stop can even be accepted when the actual, mechanical end stop has not yet been reached. It can be problematic here that the software-controlled end stops lie far in front of a maximum possible mechanical end stop.

Thereafter it has been recognized that this instance can occur in particular when the wheels have not been turned up to the mechanical end stop during the teaching-in of the software-controlled end stops. This can result in an undesired increase of the turning circle of the motor vehicle.

By determining or establishing the software-controlled end stops only after the wheels have reached a mechanical end stop, the turning circle of the motor vehicle can be optimized or respectively minimized in accordance with an exemplary embodiment.

On carrying out the method contemplated herein, the teaching-in, namely the establishing, of a software-controlled end stop is only ensured after reaching a mechanical end stop.

According to an embodiment, provision is made that a teach-in range is specified by definition of a teach-in angle, within which the software-controlled stops are to lie. The teaching-in of a software-controlled end stop thus takes place advantageously within a defined teach-in range. Such a teach-in range is necessarily owing to tolerances during the installation of the steering device into the motor vehicle.

Against this background, according to a further embodiment, provision is made that the teach-in angle is selected such that it extends between a mechanical end stop and the start of the teach-in range. The teach-in range can thus be dimensioned to be narrow such that the turning circle of the motor vehicle is, as far as possible, not increased.

According to a further embodiment, provision is made that the software-controlled end stops are only established when the mechanical end stops have been determined on both sides. It is thus advantageously prevented that a one-sided or asymmetrical teaching-in takes place.

Depending on the type of vehicle, the vehicle driver can experience a “tough” sensation on steering in the teach-in range, in so far as the method according to an embodiment has not yet been carried out.

The teaching-in and immediate storage of the software-controlled end stops can only take place after reaching the mechanical end stops on both sides. Hereby, an optimization of the turning circle is ensured. Furthermore, a one-sided teaching-in is prevented.

The mechanical end stops are reached when the steering respectively to the left or right is turned up to the stop. At this, a necessary torsion of a torsion bar is reached.

According to a further embodiment, the software-controlled end stops are determined or respectively established as a function of specified parameters. Thus, a narrowly dimensioned turning circle can be ensured by the measurement of apparatus-based values of the motor vehicle. Against this background, it is conceivable that the parameters of manual torque, current consumption, steering wheel rotation speed and/or steering angle are used.

According to a further embodiment, the software-controlled end stops are established on reaching or exceeding a specified threshold value of the torque of the servomotor. Thus, a software-controlled end stop can be established when the servomotor provides an increased power assistance in order to turn the wheels of the motor vehicle further.

According to a further embodiment, the software-controlled end stops are established on reaching or exceeding a specified threshold value of the manual torque of the vehicle driver. Hereby, a software-controlled end stop can be established when the vehicle driver must apply an increased force in order to steer the vehicle.

According to a further embodiment, the software-controlled end stops are only established when a specified threshold value of the rotation speed of the servomotor is not exceeded. Hereby, a software-controlled end stop can be established in a reliable manner with regard to the process when the servomotor of the motor vehicle must provide an increased effort in order to turn the wheels of the motor vehicle further.

According to a further embodiment, the software-controlled end stops are established on reaching or exceeding a specified threshold value of the speed of the motor vehicle. Hereby, it can be ensured that a necessary steering movement can be carried out. The speed of the motor vehicle can also be equal to zero, for example in the factory, in so far as it is ensured that the steering movement is not blocked.

According to a further embodiment, the software-controlled end stops are only established when a steering angle lies within the teach-in range. It is thus ensured that the turning circle of the motor vehicle is not increased unnecessarily.

A motor vehicle contemplated herein comprises a steering device for the wheels thereof, wherein the steering device has a servomotor and a control unit. The control unit controls the servomotor and specifies software-controlled end stops for the wheels of the motor vehicle.

The control unit, after reaching and detecting the actual, mechanical end stops of the wheels, determines software-controlled end stops.

Against this background, according to a further embodiment, the control unit of the steering device of the motor vehicle carries out a method of the type described here. By the detecting of the actual, mechanical end stop, a high degree of reliability with regard to the process is achieved at the factory. Subsequent work is avoided. The overall process of adjusting a steering device is less time-consuming Thus, a motor vehicle can be produced having a high quality.

The status of the teaching-in of the steering device can be interrogated via a diagnosis interface of the control unit. This can take place for example in the production factory or at a service station.

The determined mechanical end stops and the software-controlled end stops are advantageously stored in a memory of the control unit. They can thus be made available to the steering system and to further systems of the motor vehicle.

In another embodiment, an apparatus for determining and detecting end stops of a steering device of a motor vehicle, which has a servomotor, is provided. The apparatus comprises:
means for determining actual, mechanical end stops of the steering device and
means for establishing software-controlled end stops, after the actual, mechanical end stops are determined.

The apparatus can be constructed such that a teach-in range is specified by definition of a teach-in angle, within which the software-controlled end stops are to lie.

A further embodiment of the apparatus is configured such that the teach-in angle is selected such that it extends between a mechanical end stop and the start of the teach-in range.

In the apparatus, the establishing means can be constructed to only establish the software-controlled end stops when the mechanical end stops are determined on both sides.

The apparatus can further determine or respectively establish the software-controlled end stops as a function of specified parameters.

In the apparatus, a configuration can be selected in which the software-controlled end stops are established on reaching or exceeding a specified threshold value of the torque of the servomotor.

In addition, in an embodiment, in the apparatus the software-controlled end stops are established on reaching or exceeding a specified threshold value of the manual torque of the vehicle driver.

Also in an embodiment of the apparatus, the software-controlled end stops are only established when a specified threshold value of the rotation speed of the servomotor is not exceeded.

In an embodiment of a further structural form of the apparatus, the software-controlled end stops are established on reaching or exceeding a specified threshold value of the speed of the motor vehicle.

In further structural forms of the apparatus, the software-controlled end stops can only be established when a steering angle lies within the teach-in range.

### BRIEF DESCRIPTION OF THE DRAWINGS

The various embodiments will hereinafter be described in conjunction with the following drawing figures, wherein like numerals denote like elements, and wherein:

FIG. 1 is a diagrammatic view of a steering device of a motor vehicle, which has a servomotor and an electronic control unit;

FIG. 2 is in an upper view, the steering device according to FIG. 1, in a lower view a cutout, illustrated in detail, of the steering device according to FIG. 1; and

FIG. 3 is a diagrammatic representation of the mode of operation of the electronic control unit.

### DETAILED DESCRIPTION

The following detailed description is merely exemplary in nature and is not intended to limit the various embodiments of the application and uses thereof. Furthermore, there is no intention to be bound by any theory presented in the preceding background or the following detailed description.

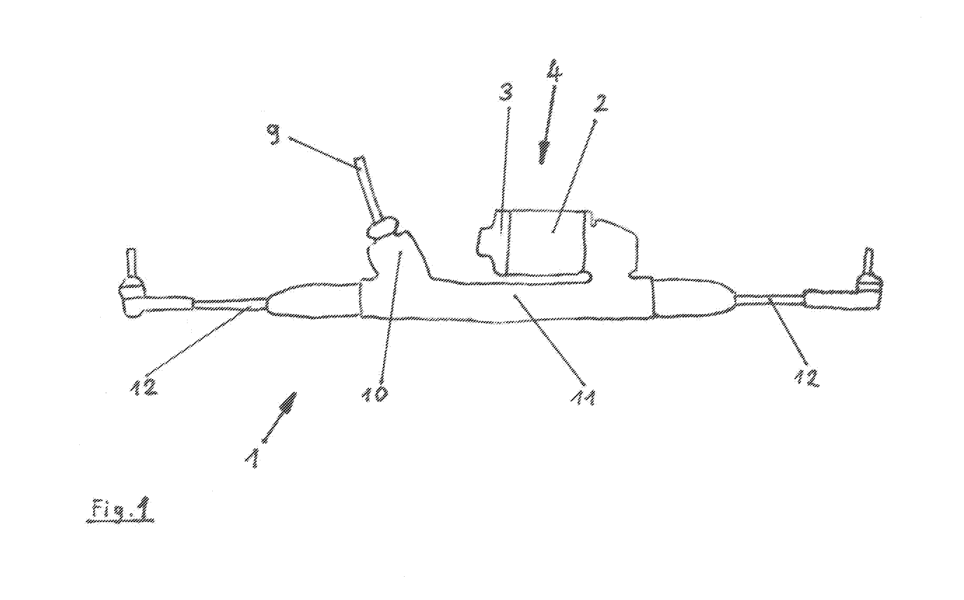

FIG. 1 shows a steering device 1 for the wheels of a motor vehicle, wherein the steering device 1 has a servomotor 2 and a control unit 3, wherein the control unit 3 controls the servomotor 2 and wherein the control unit 3 specifies software-controlled end stops for the wheels of the motor vehicle. The servomotor 2 and the control unit 3 are configured as one structural unit 4.

The method described above is generally implemented in a computer-aided manner by the control unit 3. The control unit 3 is of conventional construction here and has a microprocessor, a working memory (RAM) and a storage means for the depositing or respectively storing of a computer program, typically a flash memory. The control unit 3 can have, in addition, an input port, in order to supply to the control unit 3 the data which represent the computer program, in order to deposit it in the flash memory. Alternatively, the control unit 3 has a receiving part, by means of which the computer data arrive wirelessly or respectively via a radio connection to the control unit 3. According to its type, the control unit can be an embedded controller, i.e. it is physically connected structurally with the steering device, or respectively forms a structural unit therewith.

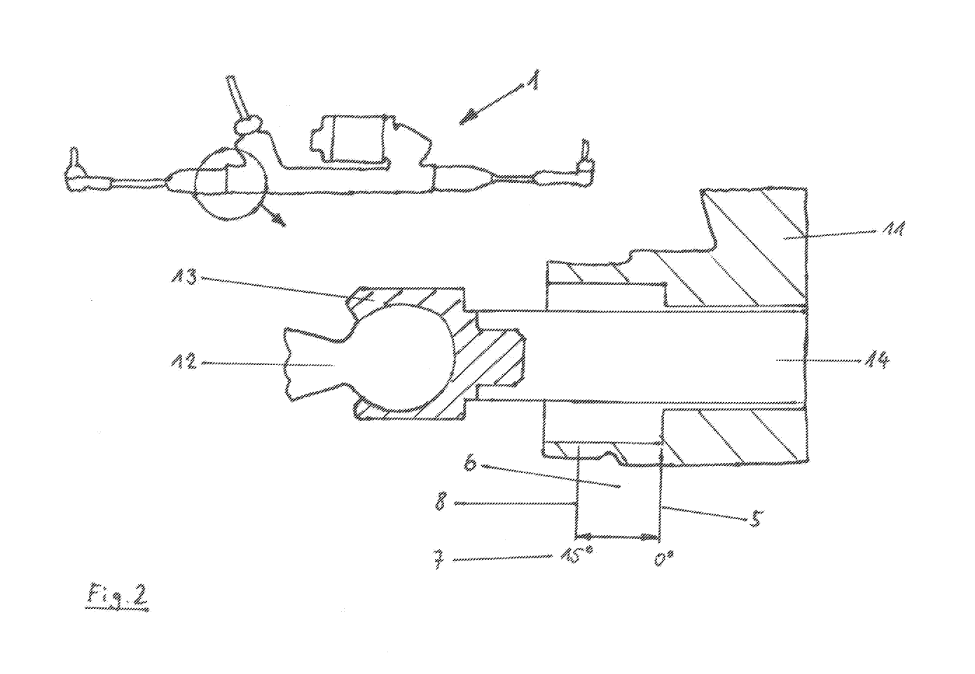

FIG. 2 shows in an upper view the steering device 1 according to FIG. 1 and in a lower view a detailed illustration of the encircled area of the upper view.

The control unit 3 determines software-controlled end stops after reaching and detecting the actual, mechanical end stops 5 of the wheels.

The control unit 3 stores the software-controlled end stops in a memory, preferably in an EEPROM (electrically erasable programmable read-only memory).

The control unit 3 carries out a method of the type described below.

The method for determining and detecting end stops of a steering device 1 of a motor vehicle, wherein the steering device 1 has a servomotor 2, comprises the following steps.

In a first step, the actual, mechanical end stops 5 of the steering device 1 are determined. In a subsequent step, the software-controlled end stops are established.

The software-controlled end stops are virtual stops. These are produced by the control unit 3, although the wheels could be turned further or respectively the rotation axes thereof could be inclined about a further angle towards the longitudinal axis of the motor vehicle.

The mechanical end stops 5 constitute the actual structurally specified stops which establish the end positions of the wheels of a motor vehicle.

In a further step, a teach-in range 6 is specified by definition of a teach-in angle 7, within which the software-controlled end stops are to lie.

The teach-in range 6 or respectively the teach-in angle 7 is represented diagrammatically in FIG. 2 by a translatory distance.

In fact, however, a teach-in angle 7 is an angle by which the rotation axes of the wheels of the motor vehicle can be inclined towards its longitudinal axis. In so far as the wheels are situated at their respective mechanical end stop 5, the rotation axes of the wheels form a limit angle with the longitudinal axis of the motor vehicle.

The teach-in angle 7 is selected such that it extends between a mechanical end stop 5 and the start 8 of the teach-in range 6.

The teach-in range 6 directly adjoins the mechanical end stop 5 of the steering device 1 or respectively of the wheels.

The software-controlled end stops are only established when the mechanical end stops 5 are determined on both sides.

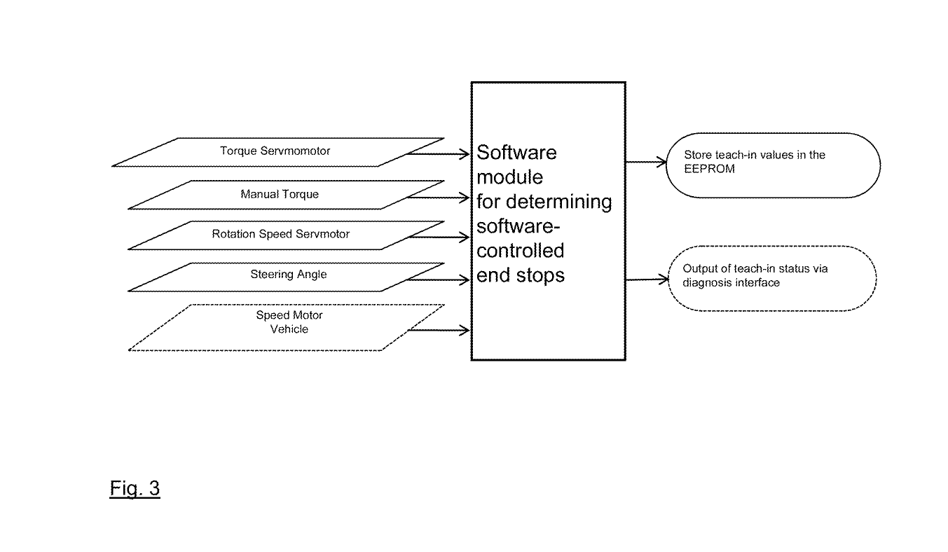

FIG. 3 shows diagrammatically that the software-controlled end stops are determined or respectively established as a function of specified parameters.

A software module of the control unit 3 determines particular parameters and then establishes the software-controlled end stops.

The teach-in values belonging to the software-controlled end stops are stored in the control unit 3 immediately after determining. No ignition cycle has to be passed through for storing the teach-in values.

The software module permits a reading of the teach-in status of the steering device 1.

The software-controlled end stops are established on reaching or exceeding a specified threshold value of the torque of the servomotor 2.

The software-controlled end stops are established on reaching or exceeding a specified threshold value of the manual torque of the vehicle driver.

The software-controlled end stops are established when a specified threshold value of the rotation speed of the servomotor 2 is not exceeded.

The software-controlled end stops are established on reaching or exceeding a specified threshold value of the speed of the motor vehicle. The speed of the motor vehicle can also be equal to zero, for example in the factory, in so far as it is ensured that the steering movement is not blocked.

The software-controlled end stops are only established when a steering angle lies within the teach-in range 6.

The software-controlled end stops are thus established as a function of a steering angle. A software-controlled end stop can be detected when the steering angle lies within the defined teach-in range 6. The teach-in range 6 is necessary for tolerance reasons.

In FIG. 2 a teach-in range 6 is represented diagrammatically, which is used by a software for determining the software-controlled end stops.

The teach-in range 6 is defined by a teach-in angle 7. In concrete terms, a teach-in angle 7 of approximately 15° is represented. A particular turning circle of the motor vehicle is associated with this teach-in angle 7.

The teach-in angle 7 extends from a mechanical end stop 5 up to the start 8 of the teach-in range 6.

The structural composition of the steering device 1 is presented below.

FIG. 1 shows a steering device 1 of a motor vehicle, comprising an input shaft 9, which is in substantially torque-proof connection with a steering wheel, which is not shown.

The steering device 1 comprises a torsion bar 10 which is connected with a torque sensor.

The steering device 1 comprises the electronic control unit 3 and the servomotor 2, which are arranged on a steering gear housing 11.

A tie rod 12 extends respectively on both sides of the steering gear housing 11, with which tie rods the wheels of the vehicle, which are not shown, can be turned.

FIG. 2 shows in the lower view a detailed sectional view of the region of the steering device 1 which is surrounded by a circular cutout in the upper view.

FIG. 2 shows in the lower sectional view that a tie rod 12 is in engagement with a rack 14 via an axial joint 13. The rack 14 is held within the steering gear housing 11.

The mechanical end stops 5 and the software-controlled end stops of the steering device 1 are identical to the mechanical end stops or respectively to the software-controlled end stops of the wheels of the motor vehicle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for determining and detecting end stops of a steering device of a motor vehicle, which has a servomotor, the method comprising the steps of:
determining actual, mechanical end stops of the steering device; and
establishing software-controlled end stops after the actual, mechanical end stops are determined.

2. The method according to claim 1, wherein a teach-in range is specified by definition of a teach-in angle, within which the software-controlled end stops are to lie.

3. The method according to claim 2, wherein the teach-in angle is selected such that it extends between a mechanical end stop and a start of the teach-in range.

4. The method according to claim 1, wherein the software-controlled end stops are established when the actual, mechanical end stops have been determined on both sides.

5. The method according to claim 1, wherein the software-controlled end stops are determined or respectively established as a function of specified parameters.

6. The method according to claim 5, wherein the software-controlled end stops are established on reaching or exceeding a specified threshold value of a torque of the servomotor.

7. The method according to claim 5, wherein the software-controlled end stops are established on reaching or exceeding a specified threshold value of a manual torque of a vehicle driver.

8. The method according to claim 5, wherein the software-controlled end stops are established when a specified threshold value of a rotation speed of the servomotor is not exceeded.

9. The method according to claim 5, wherein the software-controlled end stops are established on reaching or exceeding a specified threshold value of a speed of the motor vehicle.

10. The method according to claim 5, wherein the software-controlled end stops are established when a steering angle lies within a teach-in range.

11. A motor vehicle comprising a steering device for wheels of the motor vehicle, wherein the steering device comprises:
a servomotor; and
a control unit, wherein the control unit controls the servomotor and wherein the control unit is configured to specify software-controlled end stops for the wheels of the motor vehicle and to determine the software-controlled end stops after reaching and determining actual, mechanical end stops of the wheels.

12. The motor vehicle according to claim 11, wherein the control unit is configured to determine the actual, mechanical end stops of the steering device and to establish the software-controlled end stops, after the actual, mechanical end stops are determined.
